(19) United States
(12) Patent Application Publication
(10) Pub. No.: US 2006/0222392 A1
(43) Pub. Date: Oct. 5, 2006

(54) Image forming apparatus

(75) Inventor: Hajime Asano, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/391,326

(22) Filed: Mar. 29, 2006

(30) Foreign Application Priority Data
Mar. 30, 2005 (JP) P.2005-097416

(51) Int. Cl. G03G 15/16

(52) U.S. Cl. 399/66; 399/88

(57) ABSTRACT

The invention is an image forming apparatus which transfers an image formed on a photosensitive member 11 onto a transfer material 19 at a transfer position, the apparatus includes: a transfer roller 12 which contacts with the photosensitive member 11 at the transfer position; a power supply circuit 17 which applies constant voltage to the transfer roller 12 when the transfer material 19 is reached at the transfer position; and a CPU 18 which instructs the power supply circuit 17 to do application to the transfer member, wherein at the time when the transfer material 19 is not carried, the power supply circuit 17 applies constant current to the transfer roller 12 at a current value set by the CPU 18, and measures a voltage value during that constant current application, and the CPU 18 sets as a voltage value at the time when transfer is done to the power supply circuit 17 a voltage value that the measured voltage value is added with a compensation voltage value corresponding to the transfer material 19.

### FIELD OF THE INVENTION

The present invention relates to an image forming apparatus, such as an electrostatic process copying machine and an electrostatic printer, which has an image carrier and a transfer member enabled to contact with the image carrier.

### BACKGROUND

An image forming apparatus is proposed in, for example, U.S. Pat. No. 5,450,180A, in which an image carrier and a transfer member pressing thereto are provided, a transfer material is passed through therebetween, voltage is applied to the transfer member on this occasion, and a toner image on the image carrier is transferred onto the transfer material

In the apparatus described in this document, when the toner image is reached at a transfer position at which a transfer roller being the transfer member and a photosensitive member are contacted with each other in association with the rotation of the photosensitive member, the transfer material is also reached at that position as the timing is adjusted, the transfer voltage is applied to the transfer roller by a power supply, the electric charge of the opposite polarity against the toner is applied to the back side of the transfer material, and then the toner image on the photosensitive member is transferred onto the transfer material.

The settings of the transfer voltage to the transfer roller at this time are done in consideration that the transfer roller is greatly affected by the environmental variation such as temperature and humidity and the relationship between the voltage applied thereto and the current carried therethrough (hereinafter, called “the V-I characteristic”) is greatly varied.

More specifically, the constant current is applied to the transfer roller from the power supply at the time when paper is not carried at which the transfer material does not exist at the transfer position, the voltage thus generated at the transfer roller is held, and the constant voltage is applied at this voltage at the time when the next paper is carried. Thus, it copes with the great variation in the V-I characteristic caused by the environmental variation.

For example, at the time when the normal range of ambient temperature and humidity (N/N), a constant current of 5 μA is applied at the time when paper is not carried, then a hold voltage of 750 V is obtained, while a constant voltage of 750 V is applied at the time when paper is carried, a transfer current of 2.25 μA is obtained.

Furthermore, at the time when the high range of ambient temperature and humidity (H/H), a constant current of 5 μA is applied at the time when paper is not carried, then a hold voltage of 500 V is obtained, while a constant voltage of 500 V is applied at the time when paper is carried, a transfer current of 1.54 μA is obtained.

Furthermore, at the time when the low range of ambient temperature and humidity (L/L), a constant current of 5 μA is applied at the time when paper is not carried, then a hold voltage of 2000 V is obtained, while a constant voltage of 2000 V is applied at the time when paper is carried, a transfer current of 2.0 μA is obtained.

In the method described above, it copes with the variation in the V-I characteristic at the time when paper is not carried to control the applied current value of constant current application at the time when paper is not carried. However, in practically, the characteristic variation caused by the environmental variation in the transfer system is greatly affected not only by the transfer roller but also by the environmental variation in the transfer material. Therefore, coping with the V-I characteristic variation in consideration at the time when paper is carried (the state of carrying paper) allows further highly accurate transfer.

In particular, in the use in which a transfer material has less allowance with respect to fluctuations in transfer current, this problem is more noticeable because the transfer rate is decreased.

### SUMMARY

The invention has the configuration in which an image forming apparatus which transfers an image formed on an image carrier onto a transfer material at a transfer position, the image forming apparatus including: a transfer member which contacts with the image carrier at the transfer position; a power supply circuit which applies constant voltage to the transfer member when the transfer material is reached at the transfer position; and a processor which instructs the power supply circuit to do application to the transfer member, wherein at the time when the transfer material is not transferred, the power supply circuit applies constant current to the transfer member at a current value set by the processor, and measures a voltage value obtained during that constant current application, and the processor sets as a voltage value at the time at the time when transfer is done to the power supply circuit a voltage value that the measures voltage value is added with a compensation voltage value corresponding to the transfer material.

Furthermore, the invention has the configuration in which an image forming apparatus which transfers an image formed on an image carrier onto a transfer material at a transfer position, the image forming apparatus including: a transfer member which contacts with the image carrier at the transfer position; a power supply circuit which applies constant voltage to the transfer member when the transfer material is reached at the transfer position; and a processor which instructs the power supply circuit to do application to the transfer member, wherein at the time when the transfer material is not transferred, the power supply circuit applies constant voltage to the transfer member at a voltage value set by the processor, and measures a current value obtained during that constant voltage application, and based on the applied voltage value during that constant voltage application and the measured current value, the processor calculates a voltage value when current is applied at a predetermined current value, and sets as a voltage value at the time when transfer is done to the power supply circuit a voltage value that the calculated voltage value is added with a compensation voltage value corresponding to the transfer material.

### BRIEF DESCRIPTION OF THE DRAWINGS

FIG. 1 is a perspective view illustrating the appearance of a multiple function printer using an image forming apparatus of embodiment 1 according to the invention;

FIG. 2 is a block diagram illustrating the image forming apparatus of the embodiment 1 according to the invention,

FIG. 3 is a block diagram illustrating a power supply circuit of the embodiment 1 according to the invention;

FIG. 4 is a schematic diagram illustrating calculation of an applied voltage value when constant voltage is applied in the embodiment 1 according to the invention;

FIG. 5 is a diagram illustrating the V-I characteristic in the embodiment 1 according to the invention;

FIG. 6 is a diagram illustrating the V-I characteristic in the embodiment 1 according to the invention;

FIG. 7 is a block diagram illustrating an image forming apparatus of embodiment 2 according to the invention.

FIG. 8 is a schematic diagram illustrating calculation of an applied voltage value when constant voltage is applied in the embodiment 2 according to the invention;

FIG. 9 is a block diagram illustrating an image forming apparatus of embodiment 3 according to the invention;

FIG. 10 is a block diagram illustrating a power supply circuit of the embodiment 3 according to the invention; and

FIG. 11 is an illustration of calculating the value equivalent to the applied voltage at the time when paper is not carried in the embodiment 3 according to the invention.

### DETAILED DESCRIPTION

Hereinafter, embodiments according to the invention will be described. The related descriptions of the embodiments can be used mutually.

### Embodiment 1

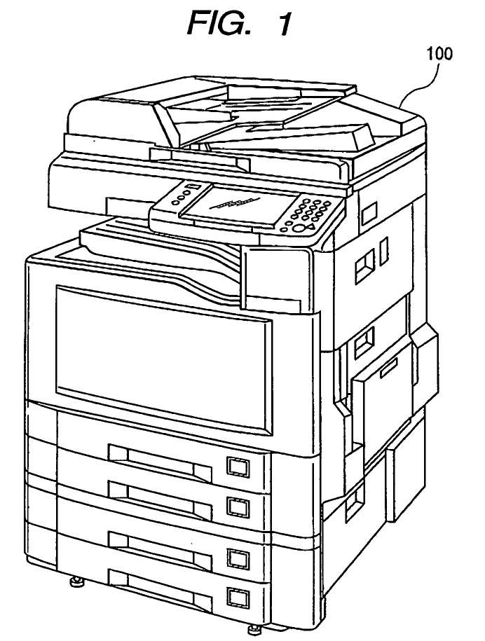

FIG. 1 depicts a perspective view illustrating the appearance of a multiple function printer using an image forming apparatus of embodiment 1 according to the invention.

In FIG. 1, 100 denotes the multiple function printer (MFP: Multi Function Printer) in which the image forming apparatus of the embodiment 1 is used in its transfer system. In addition, the use is not limited for use in the MFP, and it may be a printer such as LBP.

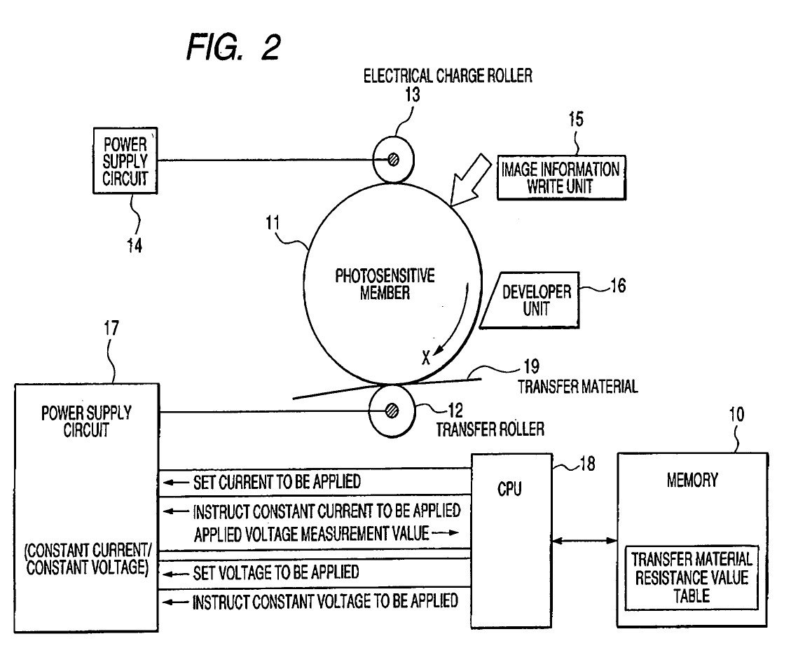

FIG. 2 is a block diagram illustrating the image forming apparatus of the embodiment 1 according to the invention.

In FIG. 2, 11 denotes a photosensitive member which is an image carrier, 13 denotes an electrical charge roller which electrically charges the photosensitive member 11, 14 denotes a power supply circuit which supplies electric power to the electrical charge roller 13, 15 denotes an image information write unit which writes image information to be printed on the surface of the photosensitive member 11, and 16 denotes a developer unit which supplies toner.

19 denotes a transfer material such as paper which is a print medium, and 12 denotes a transfer roller which is a transfer member to transfer a toner image formed on the surface of the photosensitive member 11 onto the transfer material 19.

17 denotes a power supply circuit which applies current and voltage to the transfer roller 12, 18 denotes a CPU which controls processes of electric charge, a latent image, development, and transfer, the CPU 18 setting the current value and the voltage value to be applied to the transfer roller 12 for the power supply circuit 17, and 10 denotes memory such as RAM and ROM which the CPU 18 references to data.

In addition, for the specific configurations of the basic process and the exposure part in the mode of electrophotography, US2005/0158062A1 and US2005/0190254A1 can be referenced.

Here, the detail of the configuration of the power supply circuit 17 will be described.

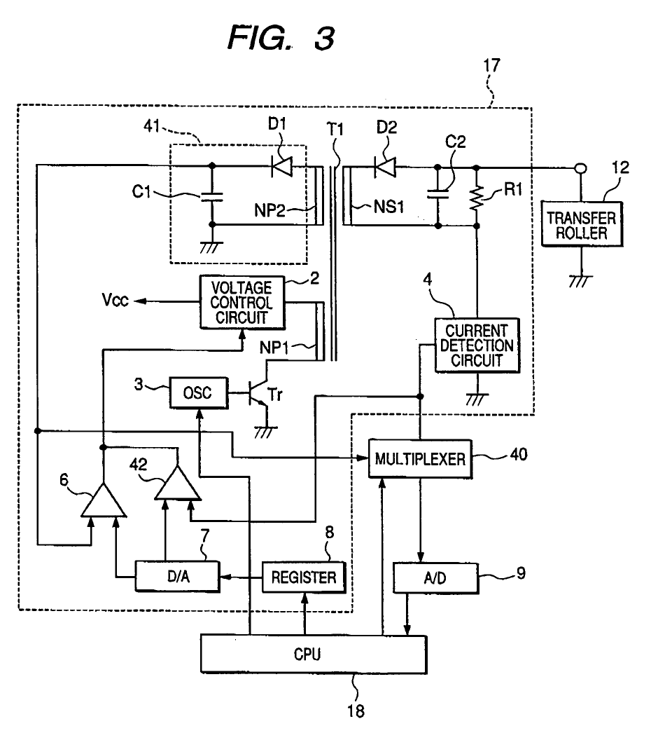

FIG. 3 is a block diagram illustrating the power supply circuit of the embodiment 1 according to the invention, showing the configuration of the power supply circuit 17. The power supply circuit 17 of the embodiment 1 has the configuration which allows the transfer roller 12 to apply both constant current and constant voltage.

In FIG. 3, 2 denotes a voltage control circuit which controls voltage to be applied to a main winding NP1 on the primary side of a transfer transformer T1, and a transistor Tr connected to the main winding NP1 drives the transfer transformer T1. 3 denotes an oscillator (OSC) which drives the transistor Tr at a fixed frequency. 4 denotes a current detection circuit which detects output current carried through the transfer roller 12 being a load, and alternate current generated at an output winding NS1 on the secondary side of the transfer transformer T1 is rectified and smoothened by a diode D2 and a condenser C2 and voltage at the output end is applied to the transfer roller 12. R1 is bleeder resistance.

6 and 42 denote a comparator, 7 denotes a D/A converter circuit, 8 denotes a register, 9 denotes an A/D converter circuit, and 40 denotes a multiplexer. 41 denotes a voltage detection circuit which detects voltage at the output end above, and configured of a detection winding NP2 on the primary side of the transfer transformer T1, a rectify diode D1, and a smooth condenser C.

The output of the current detection circuit 4 is taken in the A/D converter circuit 9 through the multiplexer 40 for analog-digital conversion, and is inputted to the CPU 18. Furthermore, the output of the voltage detection circuit 11 is also taken in the A/D converter circuit 9 through the multiplexer 40 for analog-digital conversion, and is inputted to the CPU 18. On the other hand, for settings for transfer voltage from the CPU 18, the set value is set in the register 8.

The set value of the register 8 undergoes digital-analog conversion at the D/A converter circuit 7, and is transmitted to the voltage control circuit 2 through the comparator 6 to control voltage to be applied to the main winding NP 1. Furthermore, it is transmitted to the voltage control circuit 2 through the comparator 42, and transfer output current is controlled.

The operation of the image forming apparatus thus configured will be described below.

First, a series of the basic process from electric charge to transfer will be described.

As shown in FIG. 2, the surface of the photosensitive member 11 which is rotated at a fixed process rate in the direction of an arrow X is uniformly electrically charged by the power supply 14 through the electrical charge roller 13, the image information write unit 15 uses a laser beam, slit exposure, etc. that an image is modulated to write image information on the surface of the photosensitive member 11, and then the surface potential of the image portion is dropped to form an electrostatic latent image.

Then, the developer unit 16 supplies toner to the latent image to form a toner image.

When the toner image is reached at the transfer position at which the transfer roller 12 being the transfer member contacts with the photosensitive member 11 in association with the rotation of the photosensitive member 11, the transfer material 19 is also reached as the timing is adjusted, the power supply 17 allows the transfer roller 12 to apply the transfer voltage to provide electric charge of the opposite polarity against toner on the back side of the transfer material 19, and the toner image of the photosensitive member 11 is transferred onto the transfer material 19.

Next, the setting operation of transfer bias from the power supply circuit 17 to the transfer roller 12 will be described.

At the time when paper is not carried before the toner image is reached at the transfer position, the CPU 18 sets current to be applied at a predetermined current value to the power supply circuit 17, and then it instructs constant current application. It instructs the photosensitive member 11 to apply constant current not via the transfer material 19 through the transfer roller 12.

Subsequently, the power supply circuit 17 measures the applied voltage generated at the transfer roller 12, and transmits the measured value to the CPU 18.

Subsequently, the CPU 18 sets the applied voltage to the power supply circuit 17 at the voltage value in which the measured value of the applied voltage is added with the voltage value matched with the transfer material, instructs the power supply circuit 17 to apply the constant voltage at the time when paper is carried, and thus allows the toner image of the photosensitive member 11 to be transferred onto the transfer material 19.

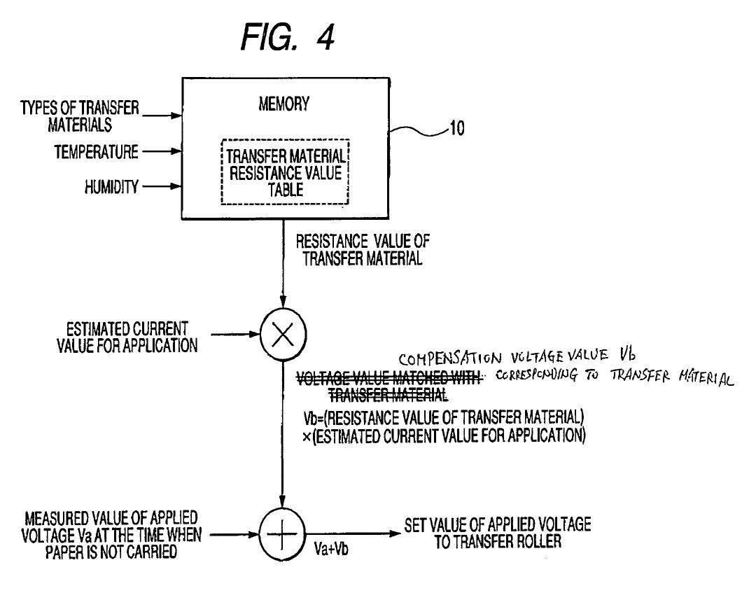

A calculation method of the applied voltage value at the time when constant voltage is applied will be described in detail with reference to FIG. 4.

FIG. 4 depicts a schematic diagram illustrating calculation of the applied voltage value at the time when constant voltage is applied in the embodiment 1 according to the invention, showing an exemplary calculation method of the applied voltage value at the time when constant voltage is applied.

As shown in FIG. 4, the memory 10 stores data of predetermined resistance values in a table form in accordance with a type of the transfer material 19.

The CPU 18 references to a transfer material resistance value table in the memory 10 based on the elements such as types of transfer materials, temperature and humidity, and determines the resistance value of the transfer material. Then, it multiples the estimated current value for application to calculate the voltage value matched with the transfer material, adds the value to the measured value of the applied voltage at the time when paper is not carried, and thus calculates the set value of the applied voltage to the transfer roller 12 at the time when paper is carried.

In addition, for the elements such as the types of the transfer materials, temperature and humidity, an input by a user and a detection circuit such as a sensor can be considered, but any of them are fine.

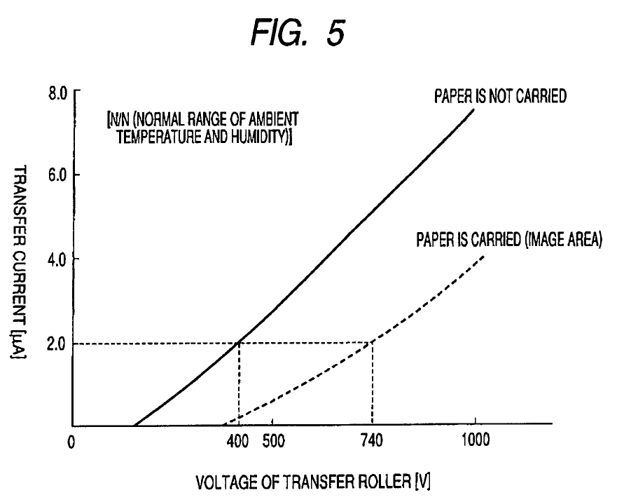

FIG. 5 depicts a diagram illustrating the V-I characteristic in the embodiment 1 according to the invention, showing an exemplary V-I characteristic of the transfer system including the transfer roller 12 at the time when paper is carried and not carried under the N/N environment, which illustrates with a concentration in the characteristic near the optimum transfer current of 2.0 μA at the time when paper is carried.

As shown in FIG. 5, when a current of 2.0 μA is applied at the time when paper is not carried in constant current application, 400 V is measured for the applied voltage value generated at the transfer roller 12. The constant voltage application is done at the time when paper is carried at a voltage value of 740 V that a voltage value of 400 V is added with a value of 340 V obtained by multiplying a resistance value of 170 MΩ of the transfer material under the N/N environment by the estimated current value of 2.0 μA for application at the time when paper is carried, and the transfer current of 2.0 μA matched with the optimum transfer current is carried to do excellent transfer.

Of course, regardless of the width of the transfer material, since 740 V is maintained at the portion of the transfer roller 12 for carrying paper even when a transfer material of full width is carried or a transfer material of narrow width is carried, the optimum transfer current of 2.0 μA can be obtained in any cases to implement excellent transfer.

In the description above, the estimated current for application at the time when paper is carried is not necessarily the same as the current to be applied when constant current is applied, which may be changed in accordance with the characteristic of the transfer material.

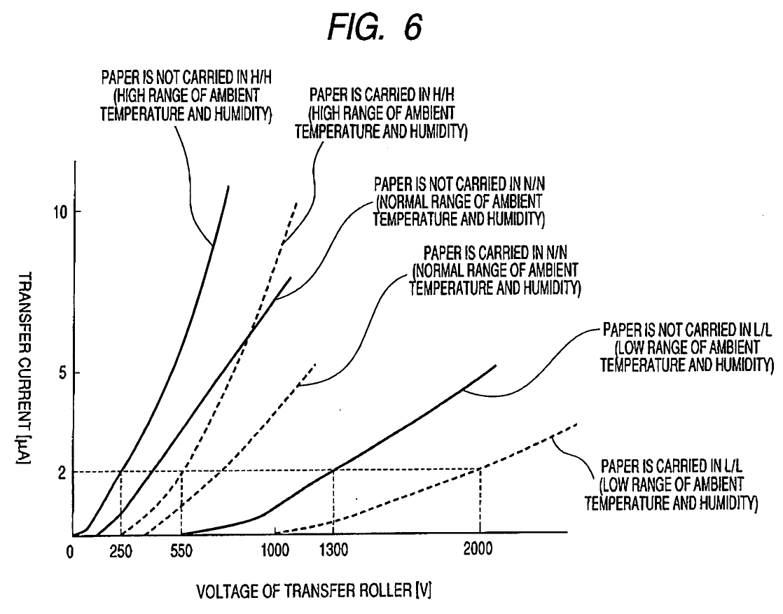

Next, the operation under the conditions of another environment will be described with reference to FIG. 6.

FIG. 6 depicts a diagram illustrating the V-I characteristic in the embodiment 1 according to the invention, showing an exemplary V-I characteristic of the transfer system including the transfer roller 12 at the time when paper is carried and not carried under various environments, which illustrates with a concentration in the characteristic near the optimum transfer current of 2.0 μA at the time when paper is carried.

As shown in FIG. 6, when a current of 2.0 μA is applied at the time when paper is not carried in constant current application under the H/H environment, 250 V is measured for the applied voltage value generated at the transfer roller 12. The constant voltage application is done at the time when paper is carried at a voltage value of 550 V that a voltage value of 250 V is added with a value of 300 V obtained by multiplying a resistance value of 150 MΩ of the transfer material under the H/H environment by the estimated current value of 2.0 μA for application at the time when paper is carried, and the transfer current of 2.0 μA matched with the optimum transfer current is carried to do excellent transfer also in the H/H environment.

When a current of 2.0 μA is applied at the time when paper is not carried in constant current application under the L/L environment, 1300 V is measured for the applied voltage value generated at the transfer roller 12. The constant voltage application is done at the time when paper is carried at a voltage value of 2000 V that a voltage value of 1300 V is added with a value of 700 V obtained by multiplying a resistance value of 350 MΩ of the transfer material under the H/H environment by the estimated current value of 2.0 μA for application at the time when paper is carried, and the transfer current of 2.0 μA matched with the optimum transfer current is carried to do excellent transfer also in the L/L environment.

Regardless of the width of the transfer material, excellent transfer can be done under the H/H environment as well as the L/L environment, which is the same as the case of the N/N environment as described above.

Furthermore, it has high adaptability not only to the environment and the width of the transfer material but also to types of transfer materials. Since the transfer material resistance value table is provided in the memory 10, bias application is facilitated in accordance with types of the transfer materials. For example, in the case of a special transfer material such as an OHP sheet having a significantly high resistance value, it is no problem as long as a high resistance value is set at the relevant part of types of the transfer materials on the transfer material resistance value table in the memory 10.

Furthermore, in the case of a special transfer material in which general transfer materials such as bond paper greatly change the resistance value depending on environments whereas a material rarely changes the resistance value even though environments are changed like an OHP sheet, it is no problem as long as the resistance value as it is set on the transfer material resistance value table 10.

As described above, bias is applied at the time when transfer is done, and thus excellent transfer can be implemented all the time regardless of environments, the width of the transfer material, and the types of the transfer materials. Therefore, an excellent image can be formed.

In addition, the transfer material resistance value table in the memory 10 is not necessarily in a table form, which may of course be in an arithmetic operation form. More specifically, for example, the same effect can be obtained also in the case in which the resistance value of the transfer material is calculated by function expressions of temperature and humidity, and these function expressions are provided for each of the types of the transfer materials.

### Embodiment 2

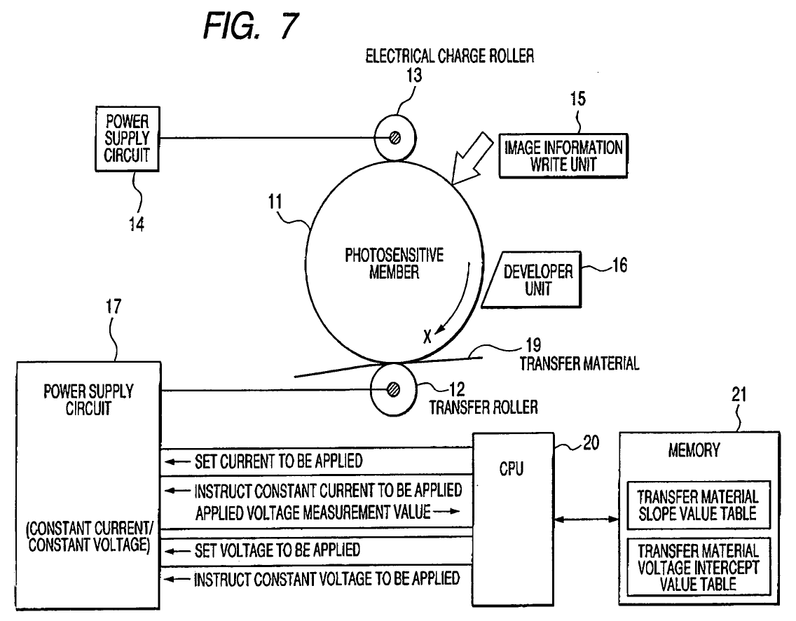

FIG. 7 is a block diagram illustrating an image forming apparatus of embodiment 2 according to the invention.

As shown in FIG. 7, the image forming apparatus of the embodiment 2 is the same as FIG. 2 shown in the embodiment 1 in that a power supply circuit 17 which allows both constant current application and constant voltage application applies a predetermined bias to a transfer roller 12 at a predetermined point in time.

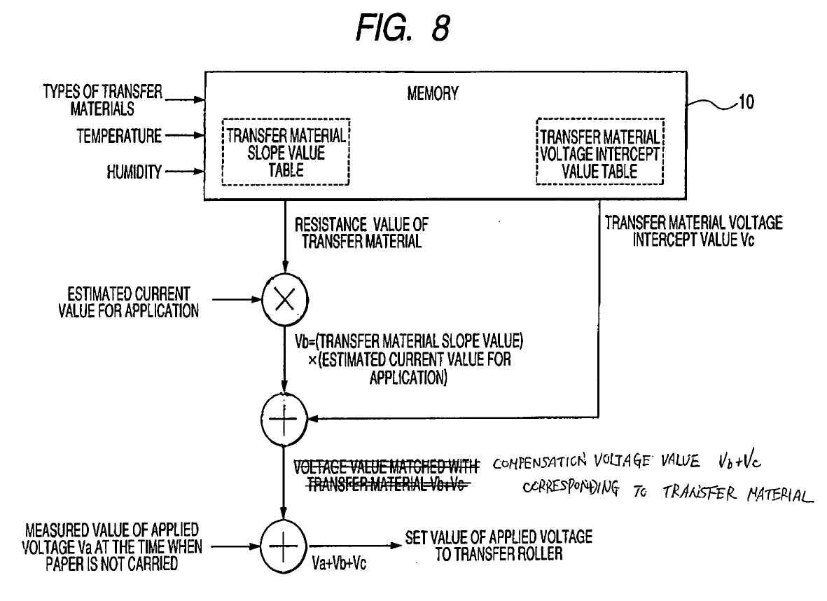

The substantial difference from the embodiment 1 is in that in the configuration shown in FIG. 7, a transfer material slope value table and a transfer material voltage intercept value table are provided in memory 21, and a calculation method of the set voltage at the time when constant voltage is applied done by a CPU 20, The calculation method of the set voltage at the time when constant voltage is applied will be described with reference to FIG. 8.

FIG. 8 depicts a schematic diagram illustrating calculation of the applied voltage value at the time when constant voltage is applied in the embodiment 2 according to the invention, showing an exemplary calculation method of the applied voltage value at the time when constant voltage is applied.

The CPU 20 references to the transfer material slope value table in the memory 21 in accordance with types of transfer materials, temperature and humidity temperature, determines a transfer material slope value, and multiplies the estimated current value for application.

Similarly, it references to the transfer material voltage intercept value table in the memory 21, adds the determined transfer material voltage intercept value, and calculates a compensation voltage value corresponding to the transfer material.

It adds the value to the measured value of the applied voltage at the time when paper is not carried, and thus calculates the set value of the applied voltage to the transfer roller 12 at the time when paper is carried.

The use of the calculation method of the applied voltage value at the time when constant voltage is applied like this to obtain the same effect as that of the embodiment 1 as well as to improve the approximate accuracy of the V-I characteristic matched with the transfer material 19 than in the embodiment 1. Therefore, an advantage can be obtained that improves the calculation accuracy of the voltage value matched with the transfer material 19 with respect to various estimated current values for application.

In addition, the transfer material slope value table in the memory 21 is not necessarily in a table form, which may of course be in an arithmetic operation form. More specifically, for example, the same effect can be obtained also in the case in which the resistance value of the transfer material is calculated by function expressions of temperature and humidity, and these function expressions are provided for each of the types of the transfer materials.

Furthermore, the transfer material voltage intercept value table in the memory 21 is not necessarily in a table form, which may of course be in an arithmetic operation form. More specifically, for example, the same effect can be obtained also in the case in which the resistance value of the transfer material is calculated by function expressions of temperature and humidity, and these function expressions are provided for each of the types of the transfer materials.

### Embodiment 3

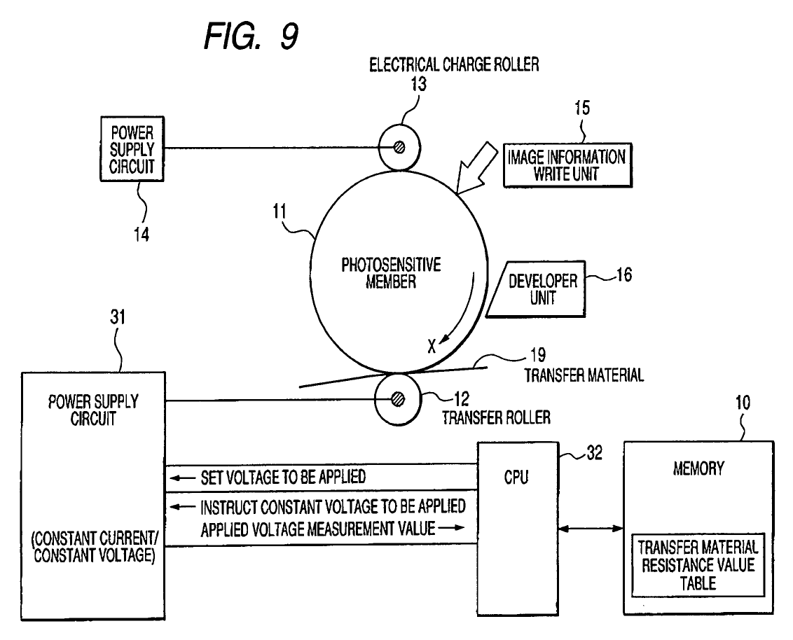

FIG. 9 is a block diagram illustrating an image forming apparatus of embodiment 3 according to the invention. As compared with the power supply circuit 17 shown in FIG. 2 in the embodiment 1, it is different in that a power supply circuit 31 shown in FIG. 9 does not apply constant current to a transfer roller 12 and applies constant voltage.

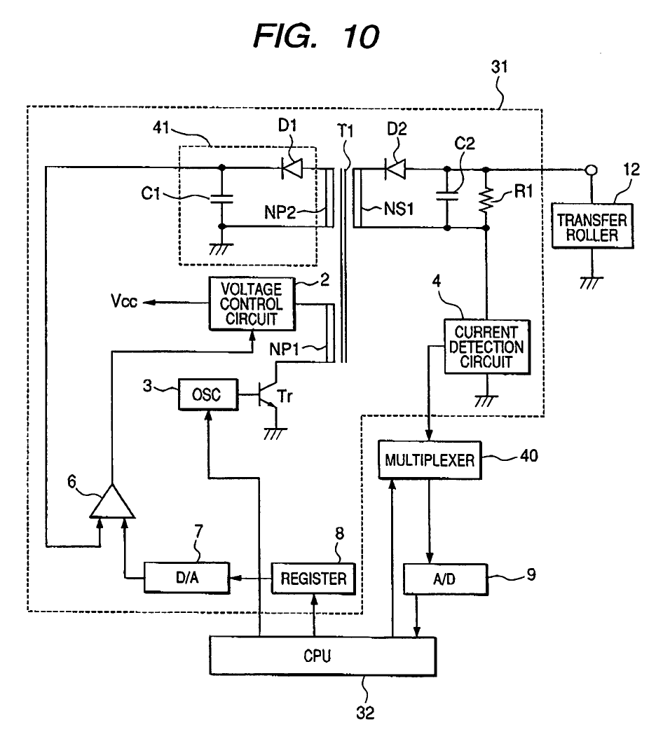

FIG. 10 is a block diagram illustrating a power supply circuit of the embodiment 3 according to the invention.

In FIG. 10, since it is unnecessary to apply constant current in the embodiment 3, the power supply circuit 31 has the configuration in which the comparator 42 that is the part to detect current error can be omitted in the configuration of the specific power supply circuit 17 shown in FIG. 3.

More specifically, the embodiment 3 is different in that the value equivalent to the applied voltage at the time when paper is not carried in the embodiment 1 is not determined by actual measurement, which is determined by calculation done by a CPU 32 from actual measurement values of the applied voltage value in constant voltage application and the current value to be carried at the time when paper is not carried.

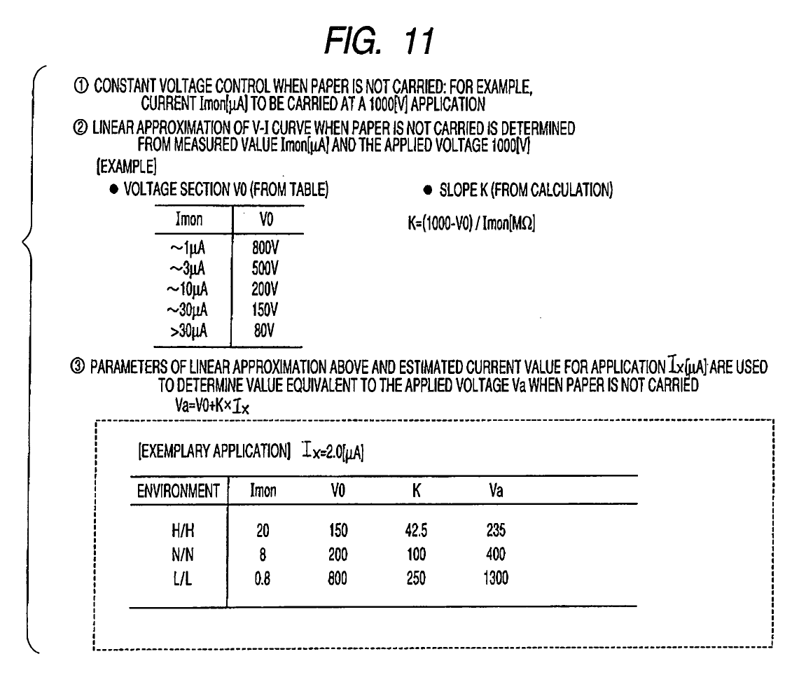

In the embodiment 3, a method of calculating to determine the value equivalent to the applied voltage at the time when paper is not carried will be described with reference to FIG. 11.

FIG. 11 is an illustration of calculating the value equivalent to the applied voltage at the time when paper is not carried in the embodiment 3 according to the invention. This shows an exemplary calculation method of the value equivalent to the applied voltage at the time when paper is not carried in the embodiment 3.

In accordance with the procedures, first, constant voltage is applied without applying constant current at the time when paper is not carried, and the value of current flowing at that time is measured.

For example, a table shown in FIG. 11 is used to determine a voltage intercept value V0 that is linear approximation of the V-I curve at the time when paper is not carried, and an equation shown in FIG. 11 is used to determine a slope K of linear approximation of the V-I curve at the time when paper is not carried. These are parameters for linear approximation of the V-I curve at the time when paper is not carried, and the linear equation for linear approximation shown in FIG. 11 can estimate the applied voltage value at a predetermined estimated current value for application.

For example, suppose a constant voltage of 1000 V is applied to measure that 20 μA is carried in the H/H environment, it can be estimated that the V0 value is 150 V and the K value is 42.5 V/μA. Thus, the applied voltage value Va at the time when paper is not carried can be calculated as 235 V at the estimated current value of 2.0 μA for application.

By the similar exemplary procedures shown in FIG. 11, it can be calculated that the Va value is 400 V in the N/N environment, and the Va value is 1300 V in the L/L environment.

Since the Va value under these environments can be made almost equal to the actual measurement values in the embodiment 1, it is treated the same as the actual measurement value in the embodiment 1. The CPU 32 references to the transfer material resistance value table in the memory 10 in accordance with the types of the transfer materials, temperature and humidity, determines the resistance value of the transfer material, multiplies the estimated current value for application to calculate the voltage value matched with the transfer material, and adds the value to the Va value. Thus, it can calculate the set value of the applied voltage to the transfer roller 12 at the time when paper is carried.

More specifically, although the power supply circuit 31 has a simple configuration because constant current is not applied application, the embodiment 3 can substantially obtain the same effect as that of the embodiment 1.

Furthermore, the set value of the applied voltage to the transfer roller 12 at the time when paper is carried may be calculated in which the CPU 32 references to the transfer material slope value table in the memory 21 in accordance with the types of the transfer materials, temperature and humidity as similar to FIG. 7 in the embodiment 2, determines the transfer material slope value, multiplies the estimated current value for application, and it similarly references to the transfer material voltage intercept value table in the memory 21, adds the determined transfer material voltage intercept value to calculate the voltage value matched with the transfer material, and adds the value to the Va value.

According to the method, the same effect as that of the embodiment 2 can be obtained even in a simple configuration not to apply constant current.

In addition, in the description above, the case is described in which the transfer roller 12 is used, but the same effect can be obtained also in the case of using a transfer belt as a contact transfer unit.

Furthermore, preferably, the settings for the transfer voltage described in the embodiments 1 to 3 are done when the power supply of an apparatus which implements the image forming apparatus according to the application is turned on, or done at periodical time intervals, or done at every predetermined number of printed sheets, or done when the environmental change is observed such as temperature and humidity.

This application is based upon and claims the benefit of priority of Japanese Patent Application No. 2005-97416 filed on Mar. 30, 2005, the contents of which are incorporated herein by reference in its entirety.

1. An image forming apparatus which transfers an image formed on an image carrier onto a transfer material at a transfer position, the image forming apparatus comprising:
a transfer member which contacts with the image carrier at the transfer position;
a power supply circuit which applies constant voltage to the transfer member when the transfer material is reached at the transfer position; and
a processor which instructs the power supply circuit to do application to the transfer member,
wherein at a time when the transfer material is not transferred, based on a measurement value obtained by applying a constant current or a constant voltage from the power supply circuit to the transfer member, the processor decides a compensation voltage value corresponding to the transfer material to determine a voltage value at a time when transfer is done, and sets the voltage value to the power supply circuit.

2. An image forming apparatus which transfers an image formed on an image carrier onto a transfer material at a transfer position, the image forming apparatus comprising:
a transfer member which contacts with the image carrier at the transfer position;
a power supply circuit which applies constant voltage to the transfer member when the transfer material is reached at the transfer position; and
a processor which instructs the power supply circuit to do application to the transfer member,
wherein at a time when the transfer material is not transferred, the power supply circuit applies constant current to the transfer member at a current value set by the processor, and measures a voltage value obtained during that constant current application, and
the processor sets as a voltage value at a time when transfer is done to the power supply circuit a voltage value that the measures voltage value is added with a compensation voltage value corresponding to the transfer material.

3. The image forming apparatus according to claim 2, wherein as a compensation voltage value corresponding to the transfer material, the processor multiplies a value matched with a resistance of the transfer material by the applied current value when constant current is applied for determination.

4. The image forming apparatus according to claim 2, wherein as a compensation voltage value corresponding to the transfer material, the processor adds a voltage intercept value when a current-voltage characteristic of the transfer material undergoes linear approximation and a value that a slope value when a current-voltage characteristic undergoes linear approximation is multiplied by the applied current value when constant current is applied for determination.

5. An image forming apparatus which transfers an image formed on an image carrier onto a transfer material at a transfer position, the image forming apparatus comprising:
a transfer member which contacts with the image carrier at the transfer position;
a power supply circuit which applies constant voltage to the transfer member when the transfer material is reached at the transfer position; and
a processor which instructs the power supply circuit to do application to the transfer member,
wherein at a time when the transfer material is not transferred, the power supply circuit applies constant voltage to the transfer member at a voltage value set by the processor, and measures a current value obtained during that constant voltage application, and
based on the applied voltage value during that constant voltage application and the measured current value, the processor calculates a voltage value when current is applied at a predetermined current value, and sets as a voltage value at a time when transfer is done to the power supply circuit a voltage value that the calculated voltage value is added with a compensation voltage value corresponding to the transfer material.

6. The image forming apparatus according to claim 5, wherein as a compensation voltage value corresponding to the transfer material, the processor multiplies a value matched with a resistance of the transfer material by the applied current value when constant current is applied for determination.

7. The image forming apparatus according to claim 5, wherein as a compensation voltage value corresponding to the transfer material, the processor adds a voltage intercept value when a current-voltage characteristic of the transfer material undergoes linear approximation and a value that a slope value when a current-voltage characteristic undergoes linear approximation is multiplied by the applied current value when constant current is applied for determination.
